(19) United States
(12) Patent Application Publication
(10) Pub. No.: US 2014/0038141 A1
(43) Pub. Date: Feb. 6, 2014

(54) USING MOBILE DEVICES IN WAGERING GAME ENVIRONMENTS

(71) Applicant: WMS GAMING, INC., Waukegan, IL (US)

(72) Inventors: Keith J. Burza, Joliet, IL (US); Damon E. Gura, Chicago, IL (US); Patrick M. Gustafson, Chicago, IL (US); David W. Hasson, Chicago, IL (US)

(73) Assignee: WMS Gaming, Inc., Waukegan, IL (US)

(21) Appl. No.: 13/787,229

(22) Filed: Mar. 6, 2013

Related U.S. Application Data
(60) Provisional application No. 61/677,879, filed on Jul. 31, 2012.

(51) Int. Cl. G07F 17/32; A63F 13/12; G09B 5/00; A63F 13/00

(52) U.S. Cl. CPC G07F 17/326; A63F 13/005; A63F 13/12; G07F 17/3288; G09B 5/00
USPC 434/128; 463/16; 463/42

(57) ABSTRACT

Some embodiments of the inventive subject matter include a computer-implemented method for providing tutorial content explaining a live casino table game. The method can include capturing a video stream of the live casino table game. The method can also include determining a game state for the live casino table game, wherein the game state includes a record of wagers for players of the live casino table game and results for the players of the live casino table game. The method can also include determining tutorial content based on the game state for the live casino table game, wherein the tutorial content includes information explaining strategy for the live casino table game. The method can also include transmitting a content stream including the video stream of the live casino table game and the tutorial content.

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2013, WMS Gaming, Inc.

### FIELD

Embodiments of the inventive subject matter relate generally to wagering game systems, and more particularly to wagering game systems that work with mobile devices.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### BRIEF DESCRIPTION OF THE FIGURES

Embodiments of the invention are illustrated in the Figures of the accompanying drawings in which:

FIG. 1 is a diagrammatic representation of a media stream including video showing a live casino table game, and tutorial content explaining aspects of the table game.

FIG. 2 shows example game statistics graphs available from some embodiments of the inventive subject matter.

FIG. 3 shows a webpage in which casual players play a live casino table game along with live casino players.

FIG. 4 is a block diagram illustrating a wagering game network 400, according to example embodiments of the invention.

FIG. 5 is a flow diagram illustrating operations for presenting tutorial content with a video stream of a live casino table game.

FIG. 6 is a flow diagram illustrating operations for presenting tutorial content with a video stream of a live casino table game.

FIG. 7 is a diagrammatic illustration of a wagering interface that facilitates betting on game events occurring on various wagering game machines.

FIG. 8 is a flow diagram illustrating operations for facilitating betting on game events occurring on various wagering game machines.

FIG. 9 shows components used for determining locations of patrons in a casino.

FIG. 10 is a flow diagram illustrating operations for providing location-based promotional material.

### DESCRIPTION OF THE EMBODIMENTS

### Introduction

This section provides an introduction to some embodiments of the invention.

Casino table games often involve numerous players playing to win common bets, such as in craps or roulette. Large groups often win and celebrate at these table games, drawing attention and interest from other casino patrons. Because of this excitement, table games are a source of fun for many casino patrons. However, some casino patrons may feel inhibited from joining the excitement because they are unfamiliar with rules and strategies for particular table games. Some embodiments of the inventive subject matter enable patrons to observe live table games (e.g., in a casino), while receiving real-time tutorial content explaining player moves in the live table games. For example, a player may receive, on a mobile phone, a video feed of a live table game. Embodiments of the inventive subject matter can overlay tutorial content over the video feed, where the tutorial content explains game strategies relevant to players at the live table game. As a result, some embodiments enable players to understand game strategies and rules as a live casino table game plays-out.

In addition to the embodiments noted above, some embodiments enable players to use mobile devices (e.g., mobile phones) to place wagers on game events occurring on wagering game machines on a casino floor. For example, a player may wager that a selected slot machine will take five reel spins before initiating a bonus game. If the selected slot machine initiates the bonus game upon completing the fifth spin, the player wins the wager. Thus, some embodiments enable players to bet on game events without being tied to a single wagering game machine on a casino floor.

In addition to the embodiments noted above, some embodiments enable players to receive promotions based on their location in a casino. Some embodiments may determine a player's location in a casino (e.g., based on GPS information provided by the player's mobile phone), and provide promotional material (e.g., coupons) relevant to the player's location. For example, if a player is playing a slot machine adjacent to a frozen yogurt stand, some embodiments may send a frozen yogurt coupon to the player's mobile phone.

### Mobile Game Tutorial for Live Casino Table Games

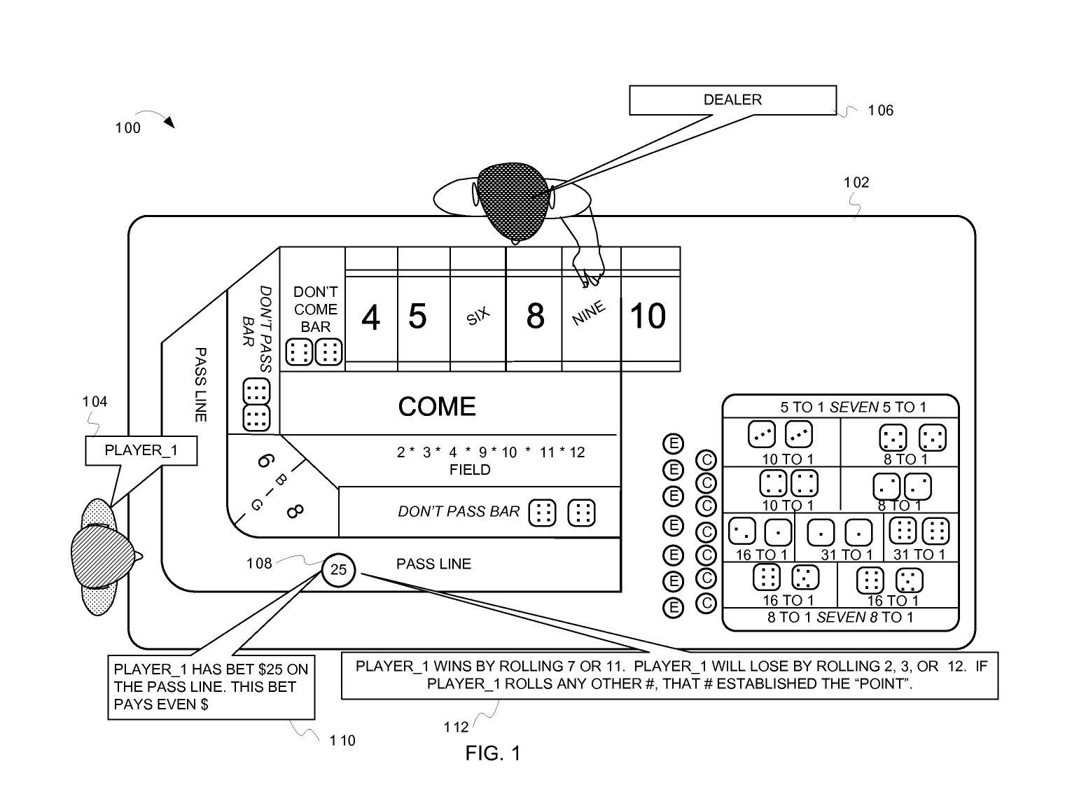

FIG. 1 is a diagrammatic representation of a media stream including video showing a live casino table game, and tutorial content explaining aspects of the table game. As the table game progresses, the tutorial content explains the player's moves/bets. Viewers (e.g., casino patrons present at the craps table 102) can view the media stream to understand what players are doing, and whether they are executing sound strategy. In some embodiments, casino patrons can receive the media stream on their mobile phones via a website.

In FIG. 1, the media stream includes a video stream 100 showing a live craps game occurring at a craps table 102 in a casino. The craps game involves a dealer and a player. The tutorial content can include balloons (e.g., see 106 and 104) identifying game participants. In FIG. 1, the tutorial content includes a balloon 104 identifying a player as “player 1” and a balloon 106 identifying the dealer. The craps game is just beginning, and the player has wagered $25 on the pass line. The video stream shows the player placing the $25 chip 108 on the pass line. The tutorial content presents balloons 110 and 112 explaining the player's pass line bet.

Although the video stream 100 shows a craps game, embodiments can show any suitable table game, such as roulette, baccarat, Texas hold 'em, etc. Furthermore, the tutorial content can explain game aspects at any level of detail, such as explaining odds, strategies, making predictions, criticizing player decisions, etc. For example, the tutorial content may explain that a poker player is likely bluffing (e.g., based on odds), or that the poker player will likely win/lose based on the system's knowledge of game state and odds.

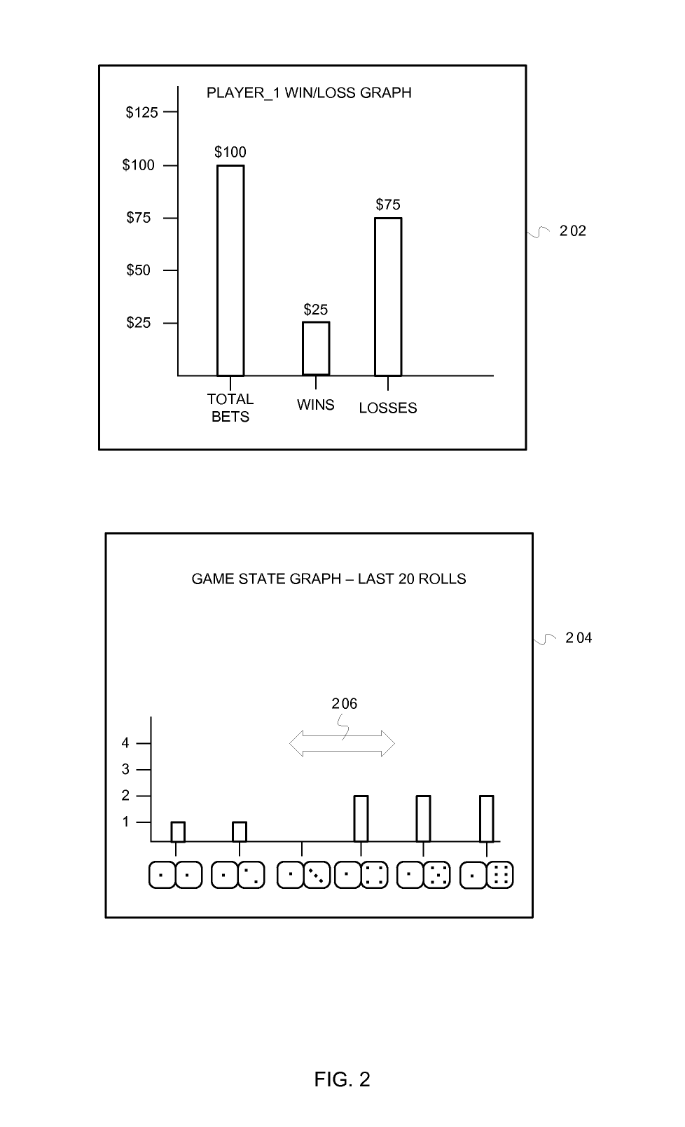

In addition to presenting tutorial content, embodiments may also provide game statistics. FIG. 2 shows example game statistics graphs available from some embodiments of the inventive subject matter. FIG. 2 includes a sample player win/loss graph 202 and sample game state graph 204. Casino patrons can access these graphs and other statistics on their mobile devices via a website.

The player win/loss graph 202 shows Player_{—}1's total bets, total winnings, and total losses for particular game session at a casino table game (e.g., the time Player_{—}1 is playing craps at the craps table 102). The game state graph 204 shows how many times each dice combination appeared over the last 20 rolls. A player can see all dice combinations by sliding the graph left and right using the control 206.

Although FIG. 2 shows only two sample graphs, embodiments can track and present any and all measurable statistics for any particular wagering game. As a result, players can view complete game state histories and statistical analyses, where game state histories include each player's wagers, moves, etc.

### Casual Games Based on Live Casino Table Games

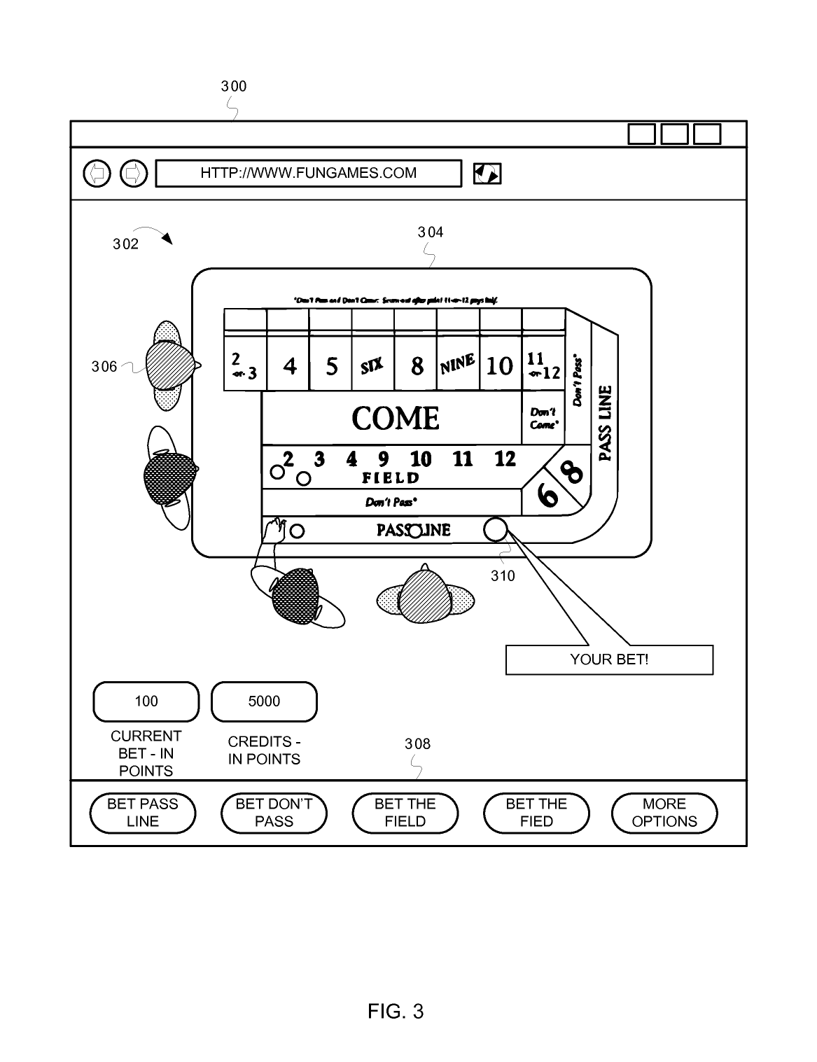

Some embodiments utilize a video stream of a live casino table game to facilitate casual games on a website. FIG. 3 shows a webpage in which casual players play a live casino table game along with live casino players. In FIG. 3, a webpage 300 includes a video stream showing players 306 playing a craps game at a craps table 304 in a casino. Casual players can play a virtual craps game “on top of” the live casino table game. As shown, the webpage 300 presents a video stream showing the live players 306 making bets and playing the craps game. Casual game players can use the game controls 308 to place non-monetary bets on the craps game. After a casual player places a non-monetary bet using the game controls 308, the system shows a graphical representation of the bet in concert with the live game. For example, if a casual player bets the pass line (using the game controls 308), the system may superimpose over the video stream a graphical representation of a gaming chip on the pass line (e.g., see the chip 302 superimposed over the video stream 310). The system can overlay graphics representing all bets made by the casual gamers. Dice rolls from the live game determine outcomes for casual bets made via the webpage. Therefore, the casual gamers can play along with live casino players. Casual players can use these casual games to learn about how live players play table games in casinos.

Although FIG. 3 shows a craps game, embodiments of the inventive subject matter can operate with any suitable casino table game. As a result, casual players can play any suitable live casino table game along with the live players.

### Operating Environment

This section describes an example operating environment and presents structural aspects of some embodiments. This section includes discussion about components that may perform functionality described herein.

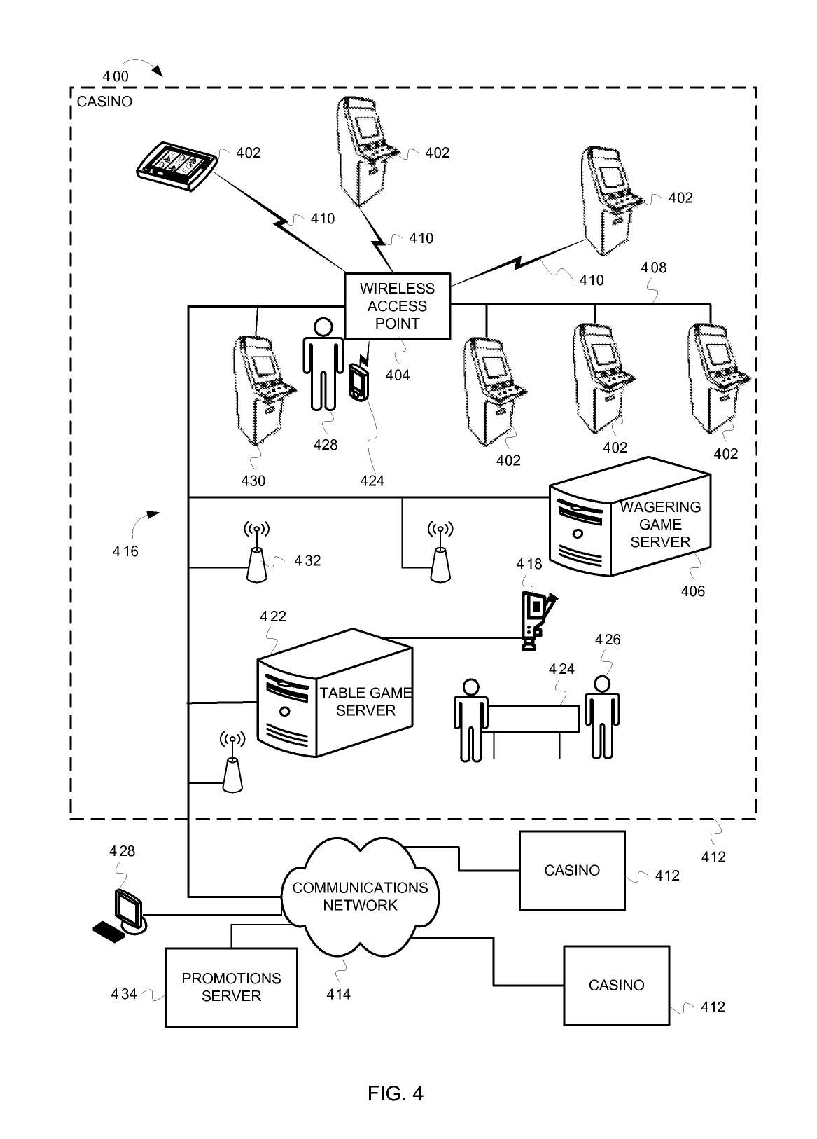

FIG. 4 is a block diagram illustrating a wagering game network 400, according to example embodiments of the invention. As shown in FIG. 4, the wagering game network 400 includes a plurality of casinos 412 connected to a communications network 414.

Each casino 412 includes a local area network 416, which includes an access point 404, a wagering game server 406, and wagering game machines 402. The access point 404 provides wireless communication links 410 and wired communication links 408. The wired and wireless communication links can employ any suitable connection technology, such as Bluetooth, 802.11, Ethernet, public wireless telephone networks, SONET, etc. In some embodiments, the wagering game server 406 can serve wagering games and distribute content to devices located in other casinos 412 or at other locations on the communications network 414.

As shown, the wagering game network 400 includes a table game server 422 connected to a camera 418. The camera 418 is positioned over a wagering game table 424 on the casino floor. The wagering game table 424 can be configured for any suitable casino table game, such as roulette, craps, baccarat, Texas hold 'em, etc. The camera 418 can capture video of players 426 playing wagering games on the table 424. The camera 418 can transmit video to the table game server 422, which can store the video. The table game server 422 can include a web server capable of distributing the video and other content (e.g., tutorial content) over the Internet to mobile phones and other computing devices (e.g., personal computers 428). In some embodiments, the table game server 422 can transmit the video stream and tutorial content described above.

The wagering game machines 402 described herein can take any suitable form, such as floor standing models, handheld mobile units, bartop models, workstation-type console models, etc. Further, the wagering game machines 402 can be primarily dedicated for use in conducting wagering games, or can include non-dedicated devices, such as mobile phones, personal digital assistants, personal computers, etc. In one embodiment, the wagering game network 400 can include other network devices, such as accounting servers, wide area progressive servers, player tracking servers, and/or other devices suitable for use in connection with embodiments of the invention.

Some embodiments of the wagering game server 406 enable players to bet on game outcomes of any of the wagering game machines 402 without being logged into any of them. To make such bets, the player 428 can walk about the casino 412 carrying a mobile device 424. Using a web interface on the mobile device 424, the player can make bets on events occurring on any of the wagering game machines 402. For example, the player 428 may place a wager on a game event occurring in a wagering game presented on the wagering game machine 430. The wagering game server 406 can process the bet and determine the outcome. The game event may include: reel combination appearing on a given pay line, whether the player will win or lose the player's wager, number of reel spins before hitting a bonus, or any other event in a wagering game occurring on any of the wagering game machines.

The wagering game network 400 also includes a promotions server 434. The promotions server 434 can select promotional material (e.g., coupons) based on a player's location. For example, a player wanders near a retail store, the promotions server 434 can award the player a coupon to the retail store. In some embodiments, the promotions server can determine a player's location using information received from a player's mobile phone (e.g., GPS information). In some embodiments, players may carry devices that provide location information by working in concert with the signal devices 432. In some embodiments, the signal devices work like those described in US20090247285A1 and US20090305773A1, each of which are incorporated herein by reference. Embodiments can employ any of the following in-door techniques for determining a player's location.
Choke Point Concepts—Location indexing and presence reporting for tagged objects, uses known sensor identification. This is usually the case with passive radio-frequency identification (RFID) systems, which do not report signal strengths and various distances of single tags or of a bulk of tags, and do not renew any before known location coordinates of the sensor or current location of any tags. Some choke point approaches may require a narrow passage to prevent tags from passing-by out of range.
Grid Concepts—Instead of long range measurement, a dense network of low-range receivers may be arranged (e.g., in a grid pattern for economy, throughout the space being observed). Due to the low range, a tagged entity will be identified by only a few close, networked receivers. An identified tag must be within range of the identifying reader, allowing a rough approximation of the tag location. Advanced systems combine visual coverage with a camera grid with the wireless coverage for the rough location.
Long Range Sensor Concepts—Such systems can use a continuous physical measurement (e.g., angle and distance, or distance only) along with the identification data in one combined signal. Long range sensors can cover an entire floor, an aisle, or just a single room.
Angle of Arrival—Angle of arrival (AoA) is the angle from which a signal arrives at a receiver. AoA is usually determined by measuring the time difference of arrival (TDOA) between multiple antennas in a sensor array. In other receivers, it is determined by an array of highly directional sensors—the angle can be determined by which sensor received the signal. AoA is usually used with triangulation to find the location relative to two anchor transmitters.
Time of Arrival—Time of arrival (ToA, also time of flight) is the amount of time a signal takes to propagate from transmitter to receiver. Because the signal propagation rate is constant and known (ignoring differences in mediums) the travel time of a signal can be used to directly calculate distance. Multiple measurements can be combined with trilateration to find a location. This is the technique used by GPS. Systems which use ToA, generally require a synchronization mechanism to maintain a reliable source of time for sensors (though this can be avoided in carefully designed systems by using repeaters to establish coupling).
Received signal strength indication—Received signal strength indication (RSSI) is a measurement of the power level received by sensor. Because radio waves propagate according to the inverse-square law, distance can be approximated based on the relationship between transmitted and received signal strength (the transmission strength is a constant based on the equipment being used), as long as no other errors contribute to faulty results. The inside of buildings is not free space, so accuracy is significantly impacted by reflection and absorption from walls. Non-stationary objects such as doors, furniture, and people can pose an even greater problem, as they can affect the signal strength in dynamic, unpredictable ways.
Inertial measurements—Other approaches for positioning of pedestrians propose an inertial measurement unit carried by the pedestrian either by measuring steps indirectly (step counting) or in a foot mounted approach, sometimes referring to maps or other additional sensors to constrain the inherent sensor drift encountered with inertial navigation. Inertial measures generally cover the differentials of motion, hence the location gets determined with integrating and thus requires integration constants to provide results.

Referring back to the wagering game machines, the wagering game machines 402 and wagering game servers 406 can work together such that a wagering game machine 402 can be operated as a thin, thick, or intermediate client. For example, one or more elements of game play may be controlled by the wagering game machine 402 (client) or the wagering game server 406 (server). Game play elements can include executable game code, random number generators, lookup tables, configuration files, game outcome, audio or visual representations of the game, game assets, etc. In a thin-client example, the wagering game server 406 can perform functions such as determining game outcome or managing assets, while the wagering game machine 402 can present a graphical representation of such outcome or asset modification to the user (e.g., player). In a thick-client example, the wagering game machines 402 can determine game outcomes and communicate the outcomes to the wagering game server 406 for recording or managing a player's account.

In some embodiments, either the wagering game machines 402 (client) or the wagering game server 406 can provide functionality that is not directly related to game play. For example, account transactions and account rules may be managed centrally (e.g., by the wagering game server 406) or locally (e.g., by the wagering game machine 402). Other functionality not directly related to game play may include power management, presentation of advertising, software or firmware updates, system quality or security checks, etc.

Any of the wagering game network components (e.g., the wagering game machines 402) can include hardware and computer readable media including instructions for performing the operations described herein. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Aspects of the present inventive subject matter are described with reference to flowchart illustrations and/or block diagrams of methods, apparatus (systems) and computer program products according to embodiments of the inventive subject matter. Each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

### Operations for Presenting Tutorial Content

The section will describe operations for presenting tutorial content, as described above vis-à-vis FIG. 1. In some embodiments, the components shown in FIG. 4 perform the operations described below.

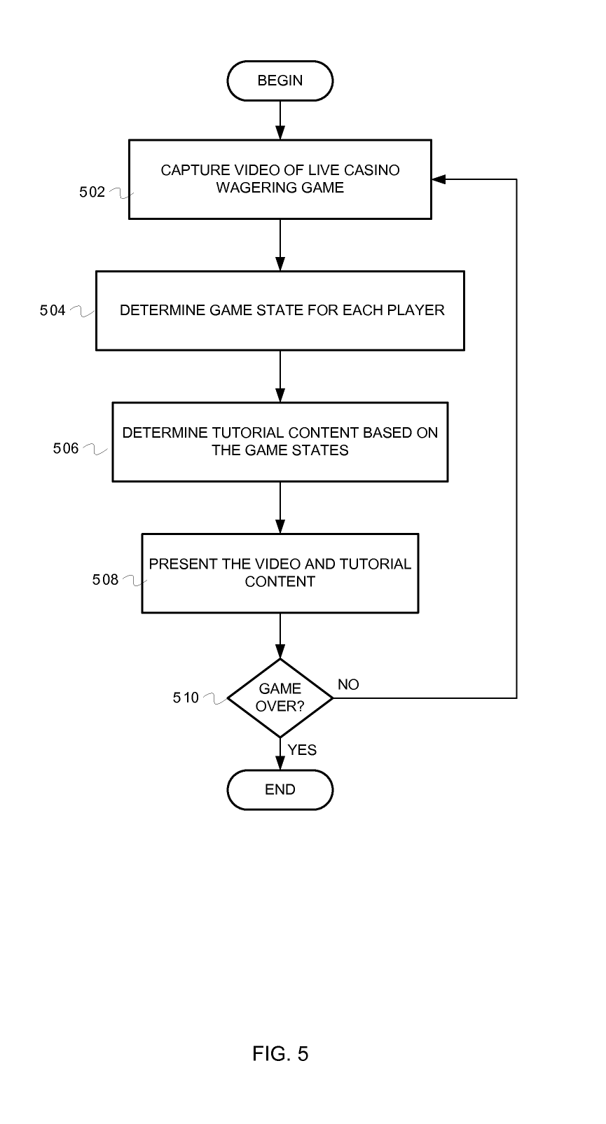

FIG. 5 is a flow diagram illustrating operations for presenting tutorial content with a video stream of a live casino table game. The operations of the flow 500 begin at block 502, where a video camera 418 captures video of a live casino table game. The video camera 418 can transmit the video stream to the table game server 422, which stores the video stream. The flow continues at block 504.

At block 504, the table game server 422 processes the video stream and determines a game state for each player. In some embodiments, the table game server 422 employs computer vision to determine wagers/moves made by each player. In other embodiments, one or more attendants enter data representing the game state for each player. In any case, the table game server 422 has information representing the entire game state. The flow continues at block 506.

At block 506, the table game server 422 determines tutorial content based on the game state. For example, the game state will indicate a player's wager and relevant game factors, such as cards in hand, dice-game point, etc. Given the game state, the table game server 422 selects tutorial content that explains the game state, strategies associated with the game state, etc. The flow continues at block 508.

At block 508, the table game server 422 presents the video stream captured at block 502 along with the tutorial content (determined at block 506). In some embodiments, the tutorial content can include graphics, text, audio, or any other suitable media. For example, the tutorial content can include an audio stream provided along with the video stream of the live casino table game. From block 508, the flow continues at block 510.

At block 510, the table game server 422 determines whether the table game is over (e.g., based on game state). If the game is over, the flow ends. Otherwise, the flow continues at block 502.

### Operations for Presenting Casual Games

The section will describe operations for presenting casual games, as described above vis-à-vis FIG. 3. In some embodiments, the components shown in FIG. 4 perform the operations described below.

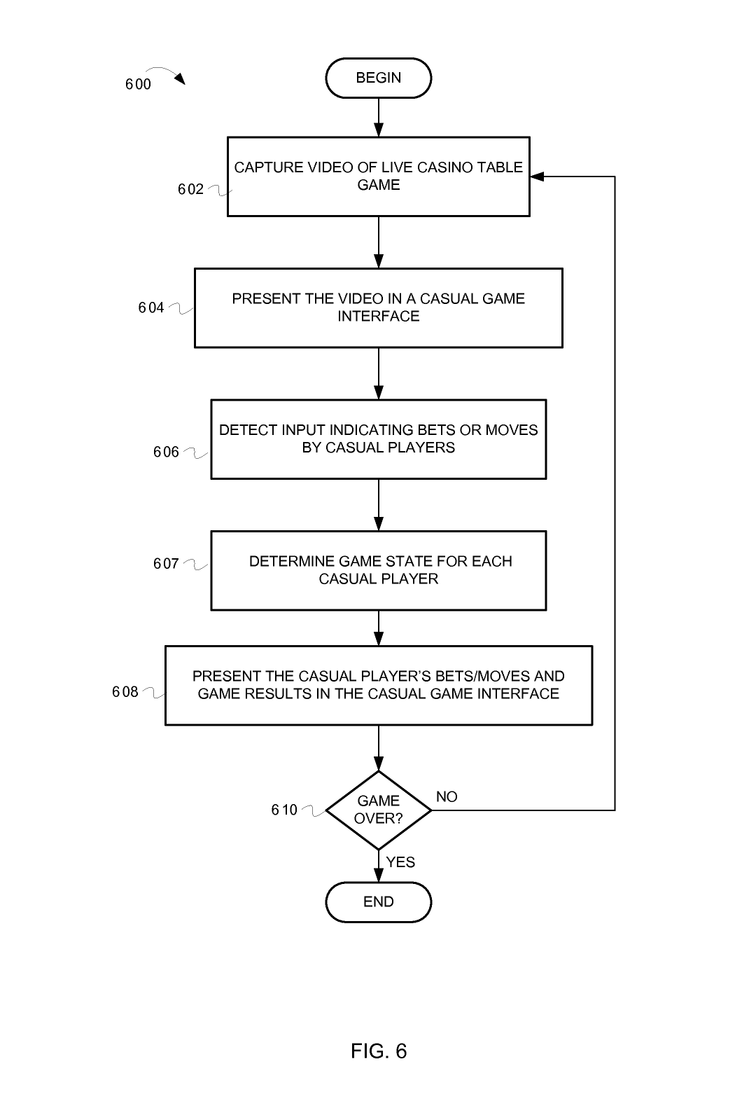

FIG. 6 is a flow diagram illustrating operations for casual games in concert with a live casino table game. The operations of the flow 600 begin at block 602, where a video camera 418 captures video of a live casino table game. The video camera 418 can transmit video stream to the table game server 422, which stores the video stream. The flow continues at block 604.

At block 604, the table game server 422 presents the video in a casual game interface accessible via the Internet. For example, casual players can use a computing device to browse to a webpage hosted by the table game server 422. In turn, the server 422 presents the video of the live casino table game in the webpage. As part of the presentation, the server 422 enables casual game players to play casual version of the table game in concert with the live casino table game. In the casual version, casual players do not wager monetary value. Instead, they may wager points or other non-monetary value. The flow continues at block 606.

At block 606, the server 422 detects input indicating wagers or moves (e.g., discards) made by the casual players. For example, the server 422 may detect that a casual player enters a bet using betting controls (e.g., see control 308 in FIG. 3) in the casual game interface. The flow continues at block 607.

At block 607, the server 422 determines a game state for each casual player. That is, the server 422 tracks each casual player's wagers/moves with respect to non-final or final game results. The flow continues at block 608.

At block 608, the server 422 presents the casual player's wagers/moves and game results in the casual game interface. For example, the server 422 may superimpose graphics that appear as if the casual player has made a wager/move in the actual live casino table game (see FIG. 3). Additionally, the server 422 resolves all nonmonetary bets based on the game state. That is, the server 422 determines whether the casual players won or lost their bets, and updates credit meters accordingly. The flow continues at block 610.

At block 610, server 422 determines whether the game is over. If the game is over, the flow ends. Otherwise, the flow continues at block 602.

### Game Event Wagering from Mobile Devices

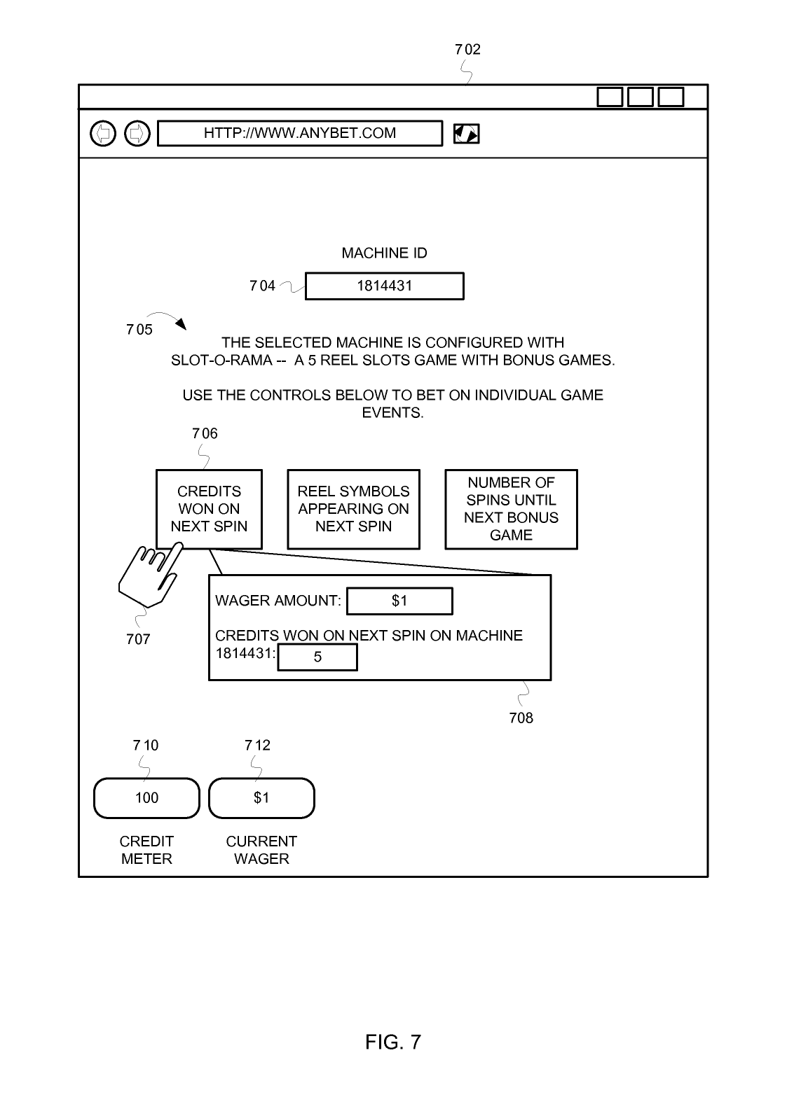

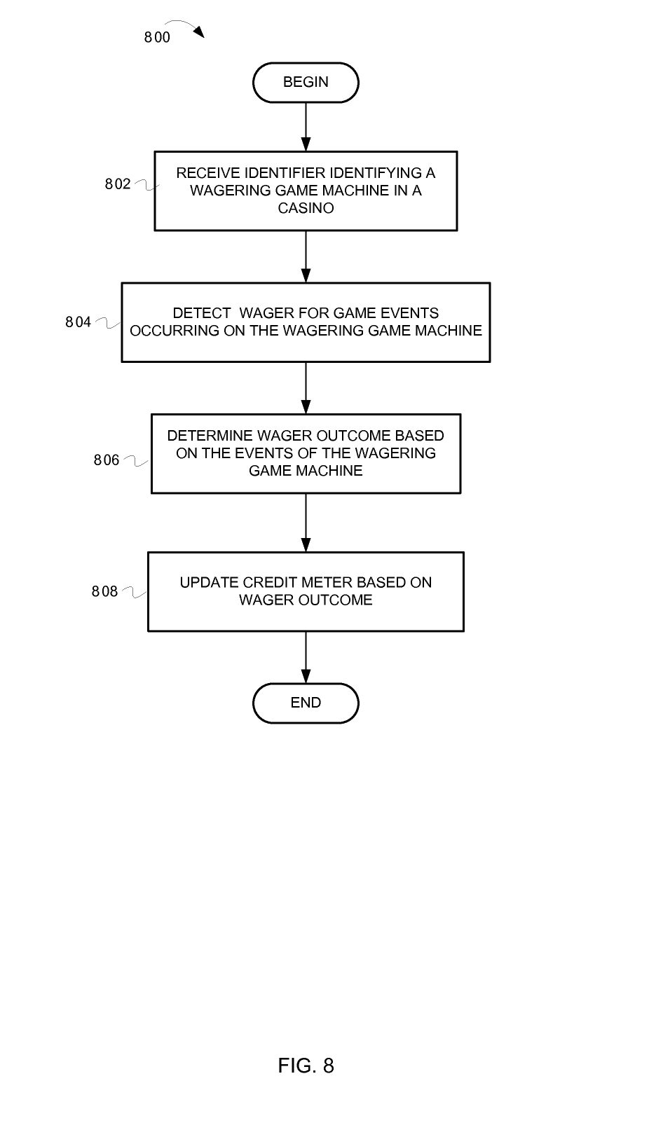

As noted above, some embodiments enable casino patrons to use their mobile devices to make wagers on game events occurring on various wagering game machines. For example, a patron may be walking about a casino floor when a particular wagering game machine catches the patron's attention. If a player is playing wagering games on the wagering game machine, the patron can use a mobile device to make bets on game events occurring on the wagering game machine. FIGS. 7 and 8 show how some embodiments facilitate such wagering.

FIG. 7 is a diagrammatic illustration of a wagering interface that facilitates betting on game events occurring on various wagering game machines. As shown in FIG. 7, the wagering interface is implemented as a webpage 702. To allow wagering on game events occurring on a particular wagering game machine, the system must identify the particular wagering game machine. In FIG. 7, the webpage 702 includes a machine identification field 704 in which a player can enter an ID code identifying a particular wagering game machine. In some instances, the ID code appears on the wagering game machine, and the patron enters the code in the field 704. After identifying the wagering game machine, the webpage 702 indicates the type of games being presented on the machine (see the message 705).

Based on the type of wagering game being presented on the selected wagering game machine, the webpage 702 presents betting controls 706 that define predefined bets relevant to the wagering game. In some embodiments, the bets are not available to players playing the wagering game. That is, the wagering interface facilitates game event wagers that players cannot make at the wagering game machines. The patron 707 can select a pre-defined bet, and enter a bet amount and other parameters in a wager information window 708. The predefined bets can identify any suitable wagering game event. In FIG. 7, the patron 707 has bet on the number credits that will be won on the wagering game machine's next slot reels spin. That is, the patron 707 is betting $1 that the player at the wagering game machine will win five credits on the next real spin. If the player wins five credits on the next spin, the patron wins $1. Otherwise, the patron loses. The webpage 702 shows the wager amount on the wager meter 712, and the patron's wins/losses on the credit meter 710.

This discussion will continue with a description of operations for facilitating betting on game events occurring on various wagering game machines. In some embodiments, the operations are performed by the components shown in FIG. 4.

FIG. 8 is a flow diagram illustrating operations for facilitating betting on game events occurring on various wagering game machines. In FIG. 8, a flow 800 begins at block 802, where the wagering game server 406 receives and identifier identifying a wagering game machine in a casino. In some embodiments, the identifier is received via a wagering interface (e.g., a webpage), where a patron manually enters the identifier in a data field of the interface. In other embodiments, the patron may take a photograph a wagering game machine or an identifier (e.g., bar code, quick response code, etc.) mounted on the machine. In turn, the wagering game server 406 may receive the photograph and process it to identify the machine. The flow continues at block 804.

At block 804, wagering game server 406 detects a wager on one or more game events occurring on the wagering game machine. For example, as discussed in FIG. 7, a player may use controls 706 to place a bet on an event occurring on the wagering game machine. In turn, the server 406 receives information indicating the wager. The game event can be any suitable portion of the game state for the wagering game on the machine. For example, for slots, the game event can be a given reel combination on a given pay line, number of spins until next bonus game, whether the player wins a wager on the next spin, etc. For card games, the game event can be what future cards will be, who will win the game, etc. In some embodiments, the bet is not available to players at the wagering game machines. That is, the wagering game machine may not offer players an ability to wager on game events such as the number of spins until the next bonus game, etc. The flow continues at block 806.

At block 806, the wagering game server 406 determines an outcome for the wagering game, where the outcome is based on game events occurring on the wagering game machine. For example, if the bet were on a reel combination for a given pay line on the wagering game machine, the server 406 determines whether the pay line included the particular reel combination. The flow continues at block 808.

At block 808, the server 406 updates credit meters. If the patron won the wager, the server 406 adds the wager amount to the credit meter. Otherwise, the server 406 reduces the credit meter by the wager amount. From block 808, the flow ends.

### Location-Based Promotions

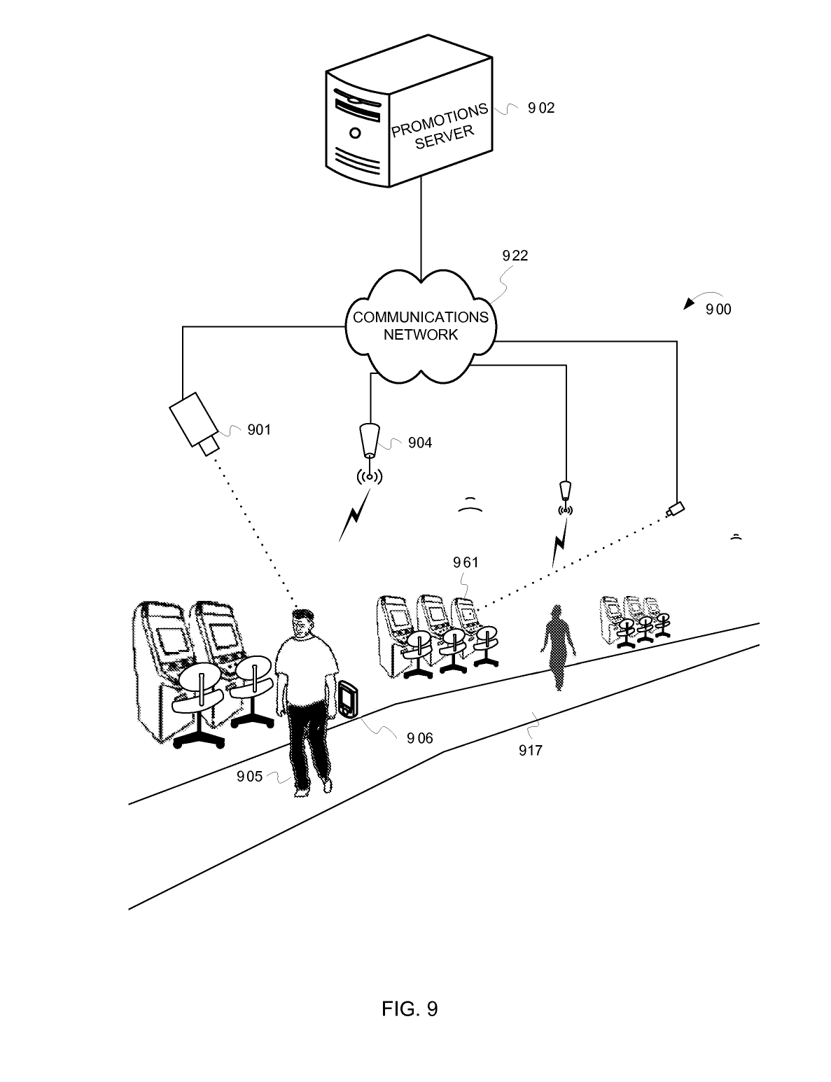

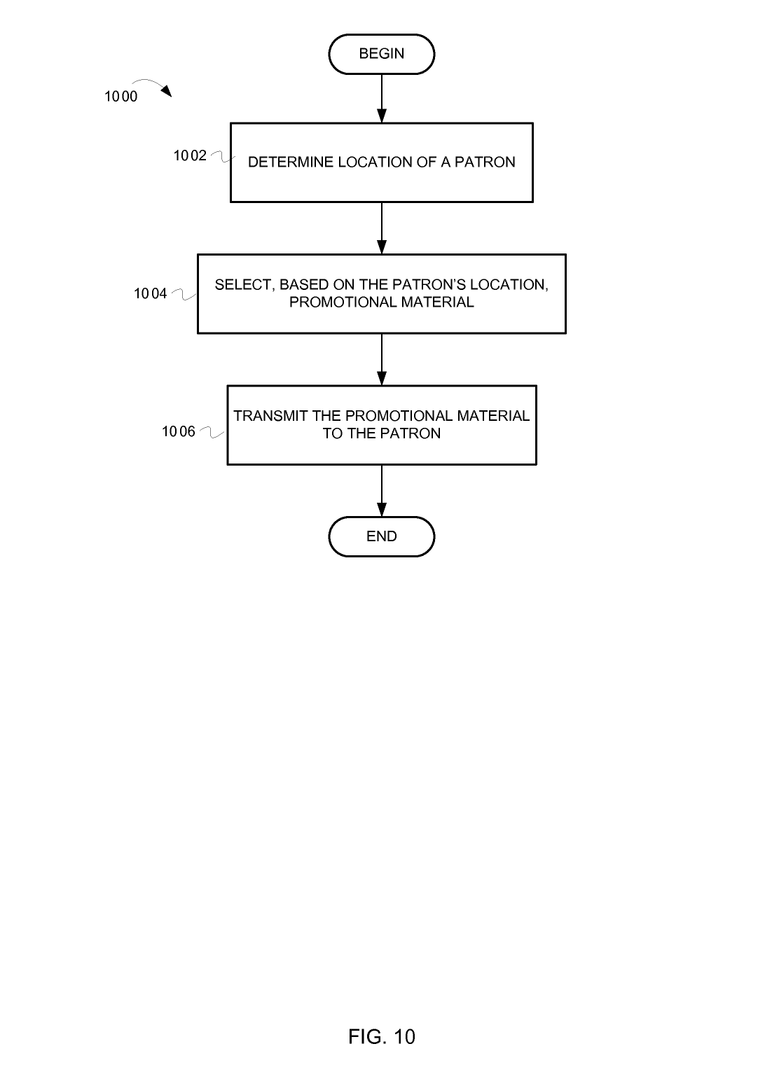

Some embodiments of the inventive subject matter provide promotional material based on where patrons are in a casino. For example, if a patron is playing a wagering game machine located in close proximity to a retail shop, embodiments can provide the patron a coupon to the retail shop. In some instances, the coupon may have a short life (i.e., the coupon expires within minutes or hours). Embodiments can utilize various technologies to locate patrons. FIGS. 9 and 10 describe how some embodiments may provide location-based promotions.

FIG. 9 shows components used for determining locations of patrons in a casino. In FIG. 9, a promotions server 902 is connected to signaling devices 904 and cameras 901 via a communications network 922. As shown, the signaling devices 904 can be located about a casino. In some embodiments, patrons may carry devices (not shown) that communicate with the signaling devices 904, thereby indicating locations of the patrons. In other embodiments, patrons may carry mobile phones that provide location information to the promotions server 902. In FIG. 9, a patron 905 is carrying a mobile phone 906. The mobile phone 906 includes a client application or other component that transmits global positioning satellite (GPS) information to the server 902. In yet other embodiments, the cameras 901 employ computer vision to locate patrons in the casino.

After determining a patron's location, the promotions server 902 can provide promotional material relevant to the location. The server 902 can send the promotional material via e-mail or short messaging service (SMS) message, provide a link at which the promotional material may be downloaded, etc. FIG. 10 describes operations of the promotional server in greater detail.

FIG. 10 is a flow diagram illustrating operations for providing location-based promotional material. In FIG. 10, a flow 1000 begins at block 1002, where the promotions server 902 determines a location of a patron. As noted above, the promotions server 902 can receive location information from a number of devices, such as cameras and software employing computer vision, mobile phone GPS information, fixed signaling devices operating with hand-held signaling devices, etc. The flow continues at block 1004.

At block 1004, the promotions server 902 selects promotional materials relevant to the patron's location. For example, the server 902 selects coupons redeemable at stores in close proximity to the patron's location. The flow continues at block 1006.

At block 1006, the promotions server 902 provides the promotional material to the patron. In some embodiments, the server 902 e-mails or otherwise electronically delivers a coupon or other promotional material to the patron. In other embodiments, the server 902 does not transmit a coupon to the patron. Instead, the server 902 delivers the coupon to a point-of-sale at which the coupon is redeemable. Additionally, the server 902 can electronically notify the patron that the promotion is available at the point-of-sale. From block 1006, the flow ends.

### GENERAL COMMENTS

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

1. A computer-implemented method for providing tutorial content explaining a live casino table game, the method comprising:
capturing, by a camera, a video stream of the live casino table game;
determining a game state for the live casino table game;
determining the tutorial content based on the game state for the live casino table game, wherein the tutorial content includes information explaining strategy for the live casino table game;
transmitting, over a network, a content stream including the video stream of the live casino table game and the tutorial content.

2. The computer-implemented method of claim 1, wherein the tutorial content is graphically overlaying the video stream.

3. The computer-implemented method of claim 1, wherein the tutorial content stream is an audio stream accompanying the video stream.

4. The computer-implemented method of claim 1 further comprising:
compiling statistics about the casino table game based on the game state;
creating graphs showing the statistics; and
transmitting the graphs for presentation on mobile devices.

5. The computer-implemented method of claim 1, wherein the determining game state includes employing computer vision to determine the wagers and the results.

6. A computer-implemented method for conducting a casual game based on results of a live casino table game, the method comprising:
receiving a video stream of the live casino table game;
transmitting a first casual game content including the video stream for presentation in a casual game interface;
receiving, via the casual game interface, nonmonetary wagers on the live casino table game;
creating a second casual game content including graphics overlaying the video stream, wherein the graphics represent game pieces associated with the nonmonetary wagers; and
transmitting the second casual game content for presentation in the casual game interface; and
determining an outcome for the nonmonetary wagers based on the results of the live casino table game.

7. The computer-implemented method of claim 6, wherein the game pieces appear to be on a gaming table on which the live casino table game is occurring.

8. The computer-implemented method of claim 6, wherein the casual game interface is a webpage appearing on a remote mobile phone.

9. The computer-implemented method of claim 6 further comprising:
receiving information indicating the results of the live casino table game.

10. The computer-implemented method of claim 6, wherein the casual game interface appears as part of a graphical user interface presented by an application program residing on a remote mobile phone.

11. A computer readable storage medium including instructions which, when executed on one or more processors, cause the one or more processors to perform operations comprising:
receiving, from a mobile computing device, information identifying a wagering game machine located in a casino, wherein the wagering game machine is one of a plurality of wagering game machines residing in the casino;
receiving, from the mobile computing device, a wager that a game event will occur as part of a wagering game on the wagering game machine, wherein the wager that a game event will occur as part of a wagering game on the wagering game machine is not available at the wagering game machine;
determining that the game event occurred as part of the wagering game on the wagering game machine; and
providing monetary value for the wager.

12. The computer readable storage medium of claim 11, wherein the mobile computing device includes a mobile telephone.

13. The computer readable storage medium of claim 11, wherein the information identifying the wagering game machine includes a photograph of the wagering game machine.

14. The computer readable storage medium of claim 11, wherein the information identifying the wagering game machine includes a photograph of an identifier mounted on the wagering game machine.

15. The computer readable storage medium of claim 11, wherein the operations further comprise:
transmitting, to the mobile computing device, information indicating predetermined wager options for use in making the wager.

16. An apparatus comprising:
a processor;
a memory device storing instructions executable by the processor, wherein the instructions include,
instructions to capture a video stream of a casino table game, wherein the casino table game involves a game table and game pieces;
instructions to receive information indicating a game state of the casino table game, wherein the game state indicates wagers for players of the table game and movements of the game pieces;
instructions to generate tutorial content that explains the wagers and the movements of the game pieces; and
instructions to transmit the video stream and the tutorial content to mobile devices located in proximity to the game table.

17. The apparatus of claim 16, wherein the game pieces include one or more of dice, playing cards, and gaming chips.

18. The apparatus of claim 17, wherein the movements of the game pieces indicate how the players played the game pieces in the casino table game.

19. The apparatus of claim 16, wherein the tutorial content includes audio content.

20. The apparatus of claim 16, wherein the tutorial content includes graphics overlaying the video stream, wherein the graphics facilitate explanation of the wagers and the movements of the game pieces.

21. An apparatus comprising:
means for receiving, from a mobile computing device, information identifying a wagering game machine located in a casino, wherein the wagering game machine is one of a plurality of wagering game machines residing in the casino;
means for receiving, from the mobile computing device, a wager that a game event will occur as part of a wagering game on the wagering game machine, wherein the wager that a game event will occur as part of a wagering game on the wagering game machine is not available at the wagering game machine;
means for determining that the game event occurred on as part of the wagering game on the wagering game machine; and
means for providing monetary value for the wager.

22. The apparatus of claim 21, wherein the mobile computing device includes a mobile telephone.

23. The apparatus of claim 21, wherein the information identifying the wagering game machine includes a photograph of the wagering game machine.

24. The apparatus of claim 21, wherein the information identifying the wagering game machine includes a photograph of an identifier mounted on the wagering game machine.

25. The apparatus of claim 21 further comprising:
means for transmitting, to the mobile computing device, information indicating predetermined wager options for use in making the wager.
